(19) United States
(12) Patent Application Publication
(10) Pub. No.: US 2024/0070851 A1
(43) Pub. Date: Feb. 29, 2024

(54) Method for Generating Data Set for Training and Electronic Device Supporting the Same

(71) Applicant: SK Planet Co., Ltd., Seongnam-si (KR)

(72) Inventor: Yeonghyeon PARK, Cheonan-si (KR)

(21) Appl. No.: 18/455,355

(22) Filed: Aug. 24, 2023

(30) Foreign Application Priority Data
Aug. 29, 2022 (KR) 10-2022-0108649

(51) Int. Cl. G06T 7/00; G06T 7/168; G06T 7/55; G06V 10/774; G06V 10/82

(52) U.S. Cl. CPC G06T 7/001; G06T 7/168; G06T 7/55; G06V 10/774; G06V 10/82; G06T 2207/20021; G06T 2207/20081; G06T 2207/20084; G06T 2207/20212; G06T 2207/30108

(57) ABSTRACT

The present invention relates to a data set generation method and an electronic device supporting the same. The method includes collecting an original good product image and an original defect image for the purpose of generating a training data set, extracting a defective part from the original defect image, and mixing the extracted defective part with the original good product image. In the method, mixing includes performing mixing of latent vectors between the defective part and the original good product image.

### CROSS-REFERENCE TO RELATED APPLICATION

This application claims priority to Republic of Korea Patent Application No. 10-2022-0108649, filed on Aug. 28, 2022, which is incorporated by reference herein in its entirety.

### TECHNICAL FIELD

The present invention relates to a technique for generating defect data for quality inspection of a panel.

### BACKGROUND ART

Various types of displays are used in devices such as TVs, mobile phones, and tablets. Among them, LED is the most used type. LED is composed of millions of pixels, and even a small number of pixel defects significantly degrade the quality of the screen. For this reason, factories producing LED panels have performed tasks to distinguish defective panels. However, since the size of defects is generally very small and varied, it is not easy for a person to directly detect them using the human eye.

Conventionally, attempts have been made to detect defects among millions of pixels based on rules using image processing algorithms of computer vision. Representatively, there have been attempts to utilize threshold values or outlines using edge information. However, since the shapes and sizes of defects vary, it is inconvenient to find defects by adjusting the constant values used in the algorithm each time. In addition, there is an attempt at automation by introducing a machine learning algorithm to detect product defects or classify defect types in the industrial field in order to provide products of constant quality to consumers. Here, in order to verify whether the machine learning algorithm is correctly trained to perform a given task, sufficient data on good and defective products is required, and the types of defective products must also be diversified. However, due to the low frequency of occurrence of defective products, there is a limit to constructing a training data set.

### SUMMARY

In view of the above circumstances, an object of the present invention is to provide a method and device for generating a data set for defective products, which is a concept opposite to good product data that is frequently collected in industrial settings.

Various other objects of the present invention will be mentioned in the description of embodiments to be described later.

In order to achieve the above object, a method for generating a training data set according to an embodiment of the present invention may include collecting an original good product image and an original defect image, extracting a defective part from the original defect image, and mixing the extracted defective part with the original good product image. Here, mixing includes performing mixing of latent vectors between the defective part and the original good product image in a latent space of an artificial neural network. Defect data can be created through mixed results.

Specifically, performing mixing may include calculating a first latent vector by providing the original good product image as an input to a first encoder, and calculating a second latent vector by providing at least the defective part as an input to a second encoder, and mixing the first latent vector and the second latent vector.

Specifically, calculating the second latent vector may include extracting a depth map or segmentation mask corresponding to the original good product image, applying the defective part to the depth map or segmentation mask, and providing a result of applying the defective part to the depth map or segmentation mask to the second encoder as an input.

Specifically, applying the defective part to the depth map may include applying the defective part to a depth change point in the depth map.

Specifically, applying the defective part to the depth map or segmentation mask may include transforming at least one of position, size, and shape of the defective part in response to a random input or an input through an input device, and applying the transformed defective part.

Specifically, performing mixing may include performing adjustment of at least one coefficient value applied to mixing of the latent vectors.

An electronic device for supporting generation of a training data set according to an embodiment of the present invention may include a memory and a processor. The memory may store an original good product image and an original defect image. The processor is functionally connected to the memory and configured to extract a defective part from the original defect image and perform an operation of mixing the extracted defective part with the original good product image. In the mixing operation, the processor is configured to perform mixing of latent vectors between the defective part and the original good product image in a latent space of an artificial neural network. Defect data can be created through mixed results.

Specifically, the processor may be configured to calculate a first latent vector by providing the original good product image as an input to a first encoder, calculate a second latent vector by providing at least the defective part as an input to a second encoder, and then mix the first latent vector and the second latent vector.

Specifically, in relation to calculating the second latent vector, the processor may be configured to extract a depth map or segmentation mask corresponding to the original good product image, apply the defective part to the depth map or segmentation mask, and provide a result of applying the defective part to the depth map or segmentation mask to the second encoder as an input.

Specifically, in a process of applying the defective part to the depth map, the processor may be configured to apply the defective part to a depth change point in the depth map.

Specifically, in a process of applying the defective part to the depth map or segmentation mask, the processor may be configured to transform at least one of position, size, and shape of the defective part in response to a random input or an input through an input device, and apply the transformed defective part.

Specifically, in a process of performing mixing, the processor may be configured to perform adjustment of at least one coefficient value applied to mixing of the latent vectors.

According to the method and device according to an embodiment of the present invention, by automating or semi-automating the generation of a data set for training a machine learning model for defect detection or defect type classification, it is possible to reduce the waste of manpower required for constructing the data set, efficiently construct the data set, and reduce industrial costs including human resources required for data collection.

Other effects of the present invention will be mentioned in the description of embodiments to be described later.

### BRIEF DESCRIPTION OF DRAWINGS

FIG. 1 is a diagram illustrating an example of a data set generation system according to an embodiment of the present invention.

FIG. 2 is a diagram illustrating an example of an electronic device supporting data set generation according to an embodiment of the present invention.

FIG. 3 is a diagram illustrating an example of a processor according to an embodiment of the present invention.

FIG. 4 is a diagram illustrating an example of processor operation for generating a data set according to an embodiment of the present invention.

FIG. 5 is a diagram illustrating an example of a method for generating a data set according to an embodiment of the present invention.

FIG. 6 is a diagram illustrating a case of applying a data set generation method according to an embodiment of the present invention.

FIG. 7 is a diagram illustrating a hardware system for implementing an electronic device supporting data set generation according to an embodiment of the present invention.

### DETAILED DESCRIPTION

Technical terms herein are only used to describe specific embodiments and are not intended to limit the present invention.

In addition, technical terms used herein should be interpreted in terms commonly understood by those of ordinary skill in the art to which the present invention belongs, unless otherwise defined herein, and should not be interpreted in an excessively comprehensive sense or an excessively reduced meaning.

When technical terms used herein do not clearly express the subject matter of the present invention, they should be replaced with technical terms that can be correctly understood by those skilled in the art. Further, general terms used herein should be interpreted as defined in the dictionary or in context and should not be interpreted in an excessively reduced sense.

Hereinafter, preferred embodiments according to the present invention will be described in detail with reference to the accompanying drawings. The same or similar components are given the same reference numerals, and overlapping descriptions thereof will be omitted.

In describing the present invention, if it is determined that a detailed description of related known technologies may obscure the subject matter of the present invention, the detailed description will be omitted.

The accompanying drawings are only for easy understanding of the present invention, and the present invention should not be construed as being limited by the accompanying drawings. The scope of the present invention should be construed as extending to all modifications, equivalents, or substitutes other than the accompanying drawings.

Now, preferred embodiments of the present invention will be described with reference to the accompanying drawings.

The present invention relates to a data generation method in which the entire data set is constructed by mixing a large amount of good product data with a defective region (e.g., a defective part or a defective patch) extracted from a small amount of collected defect product data. In this process, for the purpose of more natural synthesis, a depth map of a normal image (or a good image) to be synthesized is first extracted, and a latent vector obtained by connecting it to an extracted defective part (or defective patch) as a synthesis target is used.

FIG. 1 is a diagram illustrating an example of a data set generation system according to an embodiment of the present invention.

Referring to FIG. 1, the data set generation system 10 according to the present invention may include a server device 200, a network 50, and an electronic device 100 supporting data set generation.

The network 50 may include at least one device capable of establishing a communication channel between the server device 200 and the electronic device 100. For example, the network 50 may include at least one of a wired network and a wireless network. When configured as a wireless network, the network 50 may include a base station, a base station controller, and a center connecting the base station controller. When configured as a wired network, the network 50 may include a wired communication interface (e.g., cable). The network 50 may provide various kinds of information (e.g., an original good product image and a defect image) stored in the server device 200 upon a request of the electronic device 100. Also, the network 50 may transfer a defect data set generated by the electronic device 100 to the server device 200.

The server device 200 may establish a communication channel with the electronic device 100 through the network 50, provide information necessary for generating a data set upon a request of the electronic device 100, and store and manage a defect data set generated by the electronic device 100. In this regard, the server device 200 may include a server communication interface for connection with the network 50, a server storage for storing information (e.g., an original good product image and a defect image) necessary for generating a data set, and a server processor for the operation of the server device 200. On the other hand, if the electronic device 100 is configured to directly process the storage of information for generating a defect data set and the storage of the generated defect data set according to an embodiment of the present invention, the server device 200 and the network 50 may be omitted.

The electronic device 100 may receive information for generating a data set from the server device 200 through the network 50. In order to receive such information for generating a data set, the electronic device 100 may establish a communication channel with the server device 200 through the network 50. When receiving the information for generating a data set, the electronic device 100 may classify the received information into an original good product image and a defect image, extract a defective part (or a defective pattern, a defective patch) from the defect image, and create a depth map or segmentation mask based on the original good product image. The electronic device 100 may firstly synthesize the depth map (or segmentation mask), created based on the original good product image, and the defective part and then synthesize the firstly synthesized data and the original good product image to generate second synthesized data, thereby performing the generation of a defect data set.

In this process, the electronic device 100 may adaptively apply at least one of a scheme of linearly mixing the original good product image and the defective part and a scheme of nonlinearly mixing by constructing an artificial neural network. For example, the electronic device 100 may generate defect data by synthesizing good product data (e.g., the original good product image) and the defective part (or the defective patch) in a latent space of the artificial neural network. In another example, the electronic device 100 may change at least one of the position, size, and form of applying the defective part in response to an external input (e.g., a user input or a designated input based on a predefined rule) in at least one of the first synthesis and second synthesis of the defective part and the depth map (or segmentation mask). In addition, the electronic device 100 may apply various types of defective parts and original good product images. For example, the electronic device 100 may apply a transformed defective part in the process of applying the defective part to the original good product image without applying the depth map (or segmentation mask). That is, in the present invention, it is not always essential to use the depth map. The electronic device 100 may refer to the depth map (or segmentation mask) in order to correct (or improve) the naturalness of synthesis, and in this regard, the electronic device 100 may synthesize the defective part in a region corresponding to a depth change point in the depth map. Meanwhile, in the case where the electronic device 100 pre-stores information for data set generation, the above-described defect data set generation may be performed without interaction with the network 50 and the server device 200.

As described above, in the process of generating the defect data set for good product inspection on a panel where a plurality of pixels are arranged, the electronic device 100 according to an embodiment of the present invention may transform the extracted defective part (or defective patch) into various forms and combine it with the original good product image, while using the linear mixing or nonlinear mixing (e.g., using the artificial neural network), allowing a user input or designated input, and using the depth map (or segmentation mask).

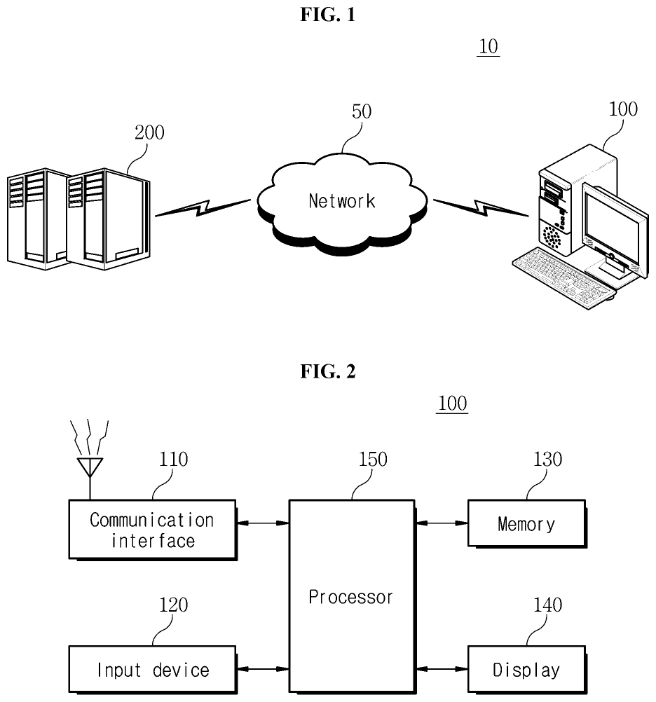

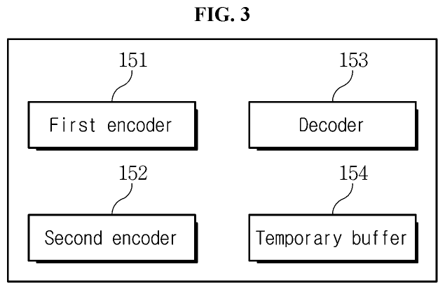

FIG. 2 is a diagram illustrating an example of an electronic device supporting data set generation according to an embodiment of the present invention.

Referring to FIG. 2, the electronic device 100 supporting data set generation according to an embodiment may include a communication interface 110, an input device 120, a memory 130, a display 140, and a processor 150.

The communication interface 110 may support a communication function of the electronic device 100. For example, the communication interface 110 may include at least one of a wired communication module and a wireless communication module. The communication interface 110 may establish a communication channel with the server device 200 through the network 50. The communication interface 110 may transmit a message requesting data set generation information to the server device 200 under the control of the processor 150 and receive the data set generation information from the server device 200. The data set generation information received by the communication interface 110 may be temporarily or semi-permanently stored in the memory 130 under the control of the processor 150. In addition, the communication interface 110 may provide the server device 200 with a defect data set generated under the control of the processor 150. Alternatively, the communication interface 110 may provide a defect data set to a designated external electronic device (e.g., a system for detecting panel defects) under the control of the processor 150.

The input device 120 may provide an input function of the electronic device 100. In this regard, the input device 120 may include a keyboard, a mouse, and various information input interfaces. For example, the input device 120 may create a user input related to transformation of a defective part extracted from a defect image and transmit the created user input to the processor 150. The user input related to the transformation of the defective part may include, for example, a user input designating at least one of size transformation, shape transformation, and position transformation of the defective part.

The memory 130 may store various programs and data related to the operation of the electronic device 100. For example, the memory 130 may temporarily or semi-permanently store data set generation information in relation to the generation of a defect data set. In addition, the memory 130 may temporarily or semi-permanently store a defect data set generated based on the data set generation information. Further, the memory 130 may temporarily store data generated through various processing processes performed in the process of generating the defect data set.

The display 140 may output various screens related to the operation of the electronic device 100. For example, the display 140 may output at least one of a screen for accessing the server device 200, a screen for receiving data set generation information, a screen for generating a defect data set, and a screen for outputting generated defect data. Also, the display 140 may output a user input screen capable of receiving a user input for transforming a defective part. Additionally, the display 140 may be provided as a touch screen including an input function. In this case, the display 140 allows the user to enter a user input for transforming the defective part.

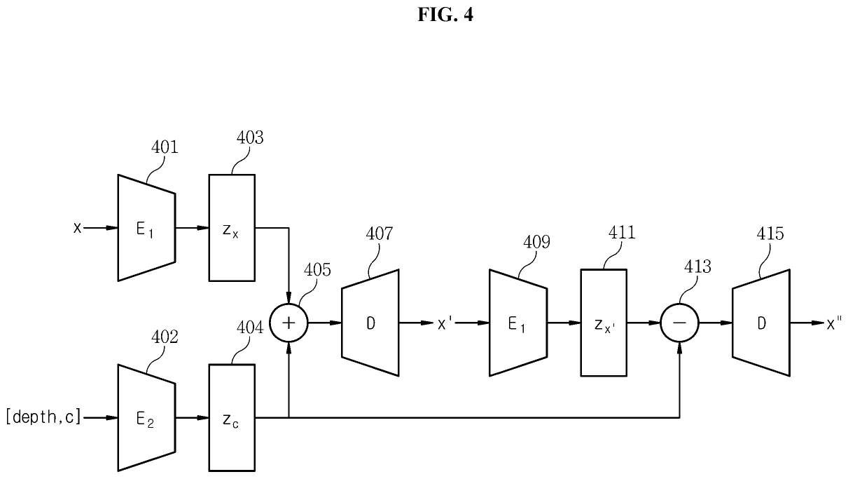

The processor 150 may process and transfer data related to the operation of the electronic device 100. For example, the processor 150 may control to request and receive data set generation information from the server device 200 based on a schedule and to store the received data set generation information in the memory 130. Also, the processor 150 may classify the data set generation information stored in the memory 130 and then generate a defect data set through processing of the classified information. In this regard, the processor 150 may include the configuration illustrated in FIG. 3.

FIG. 3 is a diagram illustrating an example of a processor according to an embodiment of the present invention.

Referring to FIG. 3, the processor 150 according to an embodiment may include a first encoder 151, a second encoder 152, a decoder 153, and a temporary buffer 154. Additionally or alternatively, the processor 150 may further include an adder and a subtractor.

The first encoder 151 may compress an input image into a latent vector. For example, the first encoder 151 may compress at least one or a plurality of original good product images into latent vectors. In addition, the first encoder 151 may compress a defect image, restored after being obtained by mixing the latent vector obtained by compressing the original good product image with data obtained by stacking a depth map (or segmentation mask) and a defective part along a channel axis, into a latent vector. The first encoder 151 may be repeatedly called, and in this case, the first encoder 151 may reuse and share parameters.

The second encoder 152 may compress data obtained by stacking the depth map (or segmentation mask) and the defective part along the channel axis into a latent vector.

The decoder 153 restores a latent vector into an image. The decoder 153 may be called several times to produce an image by restoring a result compressed into a latent vector. Alternatively, a plurality of decoders 153 may be provided and each may be operated as a dedicated decoder for restoring a specific latent vector into an image. The decoder 153 may reuse and share parameters in repeated calling processes.

The temporary buffer 154 may temporarily store input data entered into the first encoder 151 and the second encoder 152, latent vectors outputted from the first encoder 151 and the second encoder 152, restored images outputted from the decoder 153, and the like. To this end, the temporary buffer 154 may be allocated as much as needed at the time of operation of each component, or a dedicated buffer region thereof may be allocated and used for temporarily storing corresponding data. The temporary buffer 154 may include at least a partial area of the memory 130 and may be allocated under the control of the processor 150.

Using the first encoder 151, the second encoder 152, the decoder 153, and the temporary buffer 154 described above in FIG. 3, the processor 150 may construct an artificial neural network as shown in FIG. 4 to combine the defective part, the original good product image, and the depth map (or segmentation mask) in a nonlinear manner. This will be described based on FIG. 4.

FIG. 4 is a diagram illustrating an example of processor operation for generating a data set according to an embodiment of the present invention.

Referring to FIG. 4, in relation to the use of an artificial neural network for generating a data set according to an embodiment, the processor 150 may be provided with an original good product image, a depth map (or segmentation mask) generated through the original good product image, and a defective part extracted from a defect image. The above-described original good product image, depth map (or segmentation mask), and defective part may be provided by the server device 200 or pre-stored in the memory 130. For example, the processor 150 may extract a defective part from a defect image pre-stored in the memory 130 and store the extracted defective part in the memory 130. Also, the processor 150 may generate a depth map (or segmentation mask) from an original good product image and store the generated depth map (or segmentation mask) in the memory 130. In relation to the generation of the depth map (or segmentation mask), the processor 150 may extract a thermal image or color values of the original good product image and, based on the extracted color values and a predefined color index (e.g., the depth value index of each color value), generate the depth map for the original good product image. This is merely an example of generating a depth map (or segmentation mask), and a depth map generation method based on an original good product image is not limited to the above example. For example, the depth map (or segmentation mask) may be extracted from a pre-trained model, and in the case of the segmentation mask, it may be masked by a user.

Before step 401, the processor 150 may obtain at least one or a plurality of original good product images. At this time, the processor 150 may use a certain number of pre-stored original good product images or more to ensure data reliability, or may repeatedly apply various original good product images to the artificial neural network shown in FIG. 4. Similarly, before step 402, the processor 150 may collect data obtained by stacking a depth map and a defective part along a channel axis. In this regard, as described above, the processor 150 may obtain, from the memory 130 or the server device 200, a depth map (or segmentation mask) generated from an original good product image and a defective part extracted from a defect image. The depth map (or segmentation mask) corresponds to each original good product image, and a small number of defective parts obtained from a specific defect image may be used. Alternatively, a linearly transformed form (e.g., a form in which at least one of the size, shape, and position is transformed) of the initially obtained defective part may be applied to match the number of original good product images.

Meanwhile, although steps 401 and 403 and steps 402 and 404 are shown in parallel in the figure, these steps are not limited to the specific order shown. For example, steps 401 and 403 may be preceded, steps 402 and 404 may be preceded, or both may be performed simultaneously.

Upon receiving an original good product image, the processor 150 encodes the received original good product image through the first encoder 151 to output a first latent vector zₓ at step 401, and stores the first latent vector in the temporary buffer 154 at step 403.

Upon obtaining a depth map (or segmentation mask) and a defective part (e.g., retrieving the depth map and the defective part from the memory 130 or receiving them from the server device 200), the processor 150 encodes the obtained depth map and defective part through the second encoder 152 to output a second latent vector z_{c} at step 402, and stores the second latent vector in the temporary buffer 154 at step 404.

The first latent vector zₓ and the second latent vector z_{c} are mixed through the adder (+) at step 405, and the mixed data is inputted to the decoder 153 at step 407 to be restored as a defect-applied image x′.

The defect-applied image x′ outputted from the decoder 153 is inputted into the first encoder 151 and compressed through the first encoder 151 at step 409, and then stored in the temporary buffer as a third latent vector z_{x′} at step 411. The third latent vector z_{x′} stored in the temporary buffer is inputted into the subtractor (−) at step 413, and subtracted from the second latent vector z_{c} stored in the temporary buffer at step 404. The output of the subtractor (−) is restored as a good product image x″ by the decoder 153 at step 415.

The operation of the adder (+) may be performed as shown in Equation 1 below.

(1−α)zₓ+α(z_{c}) Equation 1

Here, the value of α may be 0.5 as a default value and may be changed as needed. Also, zₓ denotes the first latent vector, and z_{c} denotes the second latent vector.

In addition, the operation of the subtractor (−) may be performed as shown in Equation 2 below.

(1−β)z_{x′}+β(z_{c}) Equation 2

Here, the value of β may be 0.5 as a default value and may be changed as needed. Also, z_{x′} denotes the third latent vector, and z_{c} denotes the second latent vector.

In the present invention, an artificial neural network is used for the purpose of synthesizing a defective part in good product data. The electronic device 100 may utilize a pre-trained depth map generation model to generate a depth map (or segmentation mask) from an original image. A loss function is composed of L_{recon} and L_{distortion}, whose purposes are for minimization and maximization, respectively. In the case of L_{distortion}, it may be replaced by minimizing in negative form. In the loss function, d may be any function that can represent distance.

Meanwhile, L_{recon} may be defined by Equation 3 below.

L_{recon}=d(x,x″)+d(x*mask(c),x′*mask(c)) Equation 3

In Equation 3, x*mask(c) denotes multiplying the original good product image by a mask (in the form of a binary map) corresponding to the opposite of a synthesis target defective part c for removal. Also, x′*mask(c) denotes multiplying the defect-applied image by the same mask to thereby remove the defective part. Therefore, L_{recon} can be trained in a direction of minimizing a difference between the original good product image and the restored good product image and in a direction of minimizing a difference between the original good product image from which the synthesis target region is removed by masking and the defect-applied image to which the same mask is applied.

L_{distortion} may be defined by Equation 4 below.

L_{distortion}=d(x,x′)+d(x′,x″) Equation 4

The L_{distortion} may be trained in a direction of maximizing a difference between the original good product image and the defect-applied image and in a direction of maximizing a difference between the defect-applied image and the restored good product image.

Training is performed for finding an optimal value in the above-described loss function, and the electronic device 100 generates a defect data set by obtaining the defect-applied image x′ obtained by synthesizing a desired defective part and the original good product in the experiment step.

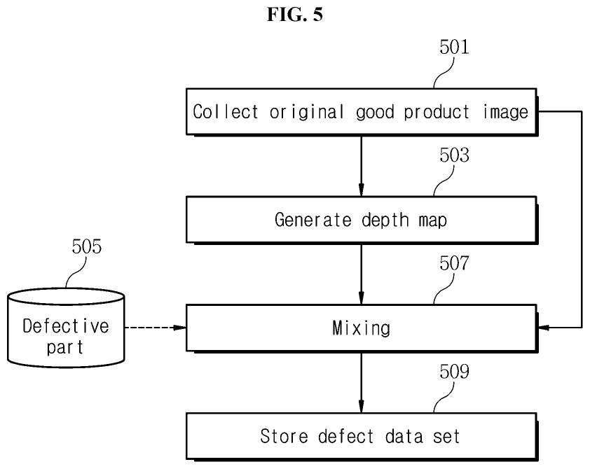

FIG. 5 is a diagram illustrating an example of a method for generating a data set according to an embodiment of the present invention.

Referring to FIG. 5, in relation to the method for generating a data set for machine learning according to an embodiment, the processor 150 of the electronic device 100 may collect an original good product image at step 501. The original good product image may include an image without defects. The original good product image may be acquired through the server device 200 or provided by a manager of the electronic device 100 or a manager who processes data set generation and support.

At step 503, the processor 150 may generate a depth map (or segmentation mask) corresponding to the collected original good product image. In relation to the generation of the depth map (or segmentation mask), the processor 150 may utilize a pre-trained depth map generation model.

Meanwhile, at step 505, the processor 150 may collect defective parts. In relation to the collection of defective parts, the processor 150 may obtain a defect image with defects. The defect image may include a defect image determined as an image having defects through preliminary evaluation. The defect image may be provided by the server device 200 or by a manager. Step 505 may be performed regardless of the order of step 501 or step 503.

At step 507, the processor 150 may mix the depth map (or a segmentation mask to replace the depth map as needed or according to system requirements) and the defective part. In this process, the processor 150 may evaluate the depth map and apply the defective part to a point where there is a change in depth. Additionally or illustratively, the processor 150 may adjust at least one of the size, position, and shape of the defective part in response to the size, position, and shape of the depth change point, and apply the adjusted defective part to the depth change point for mixing.

At step 509, the processor 150 may store a defect data set generated by mixing the depth map (or segmentation mask) and the defective part. By repeatedly performing the above-described operations, the processor 150 may accumulate and store defect data to be used for machine learning or the like. To this end, the processor 150 may collect a plurality of original good product images, generate respective depth maps (or segmentation masks) for such original good product images, and perform mixing with defective parts. In this process, the processor 150 of the electronic device 100 may acquire a natural synthesized defect image through depth-aware transformation of a synthesized result.

Meanwhile, the processor 150 of the electronic device 100 may selectively apply the depth map. For example, in relation to the data set generation method for training a machine learning model for the purpose of defect detection or defect type classification, the processor 150 constructs a data set including an original good product image and an original defect image while generating synthesized data by mixing the defective part extracted from the original defect image with the original good product image and basically processing linear mixing between latent vectors during data mixing. Here, the processor 150 may selectively apply nonlinear mixing by additionally constructing an artificial neural network. In the process of mixing data, the processor 150 may adjust the mixing intensity of defects by adjusting the coefficient α or β described in Equations 1 and 2 above. Here, the processor 150 may add a change in the amount or shape of coefficients according to mixing of three or more elements or nonlinear mixing. By accumulating and storing the data set generated through the above-described operations at least a certain amount, the processor 150 may construct a data set for training or verification.

On the other hand, in relation to constructing an artificial neural network for defective part synthesis, the processor 150 may construct a generative artificial neural network including an encoder and a decoder for synthesizing. Here, in constructing the artificial neural network, the electronic device 100 supports changing the detailed structure in various forms within the category of the generative artificial neural network. For example, a discriminator may be added to the encoder, or the generative artificial neural network may be transformed into a generative adversarial network (GAN).

In another example, the defective part synthesis may be performed by a user input through the input device 120 of the electronic device 100. For example, in the defective part synthesis, designation of a defective part or its position or size may be performed by a manually selectable/designable item in a user input or may be performed randomly. In the latter case, the defective part synthesis may be performed through complete automation. In the artificial neural network learning, pre-extracted defective parts may be subjected to rigid or affine conversion. For example, in the artificial neural network learning, previously extracted defective parts may be moved up and down or left and right before synthesis, rotated clockwise or counterclockwise before synthesis, or enlarged or reduced before synthesis, and then applied.

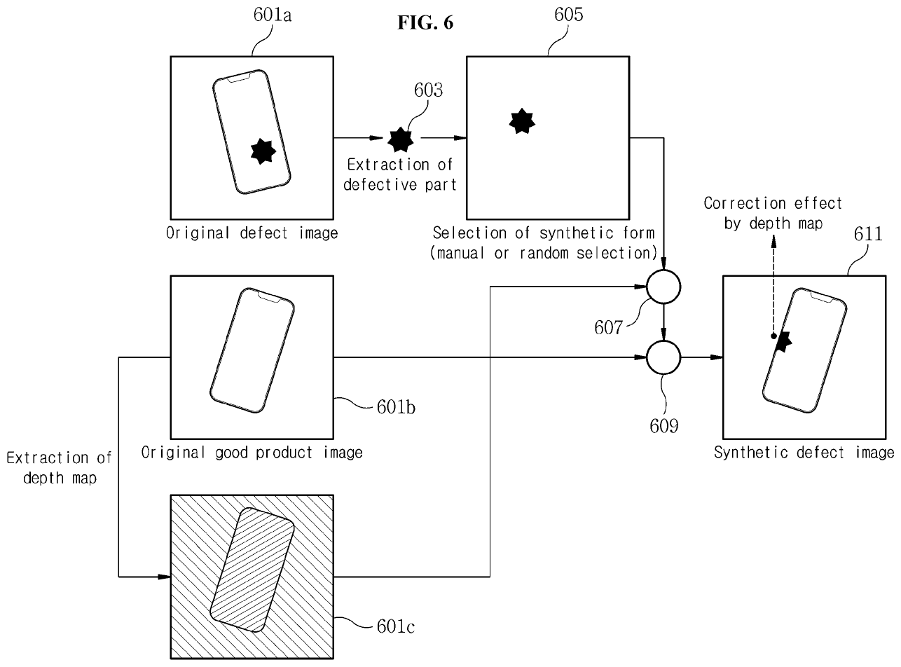

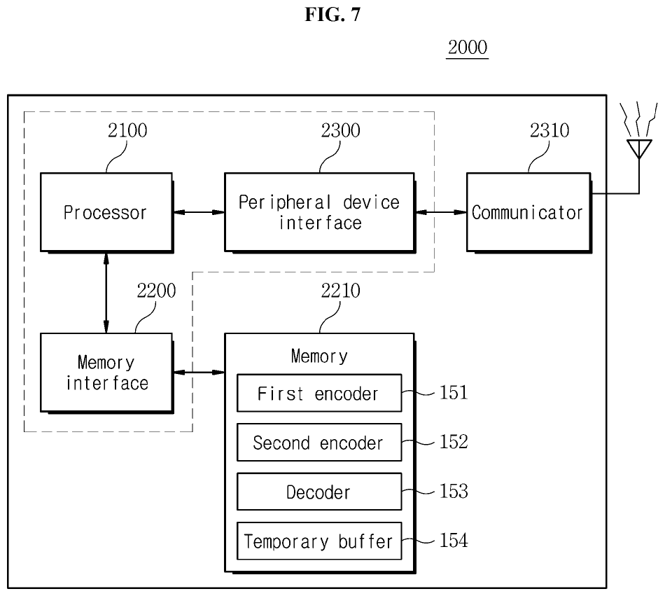

FIG. 6 is a diagram illustrating a case of applying a data set generation method according to an embodiment of the present invention.

Referring to FIG. 6, in relation to constructing a training data set for a smart phone panel, when an original defect image is collected at step 601a, the electronic device 100 may extract a defective part from the original defect image at step 603. In relation to extracting the defective part, the electronic device 100 may perform image analysis, binarization, object detection, or color evaluation on the panel to extract the defective part having a form different from the surrounding area. After extracting the defective part, the electronic device 100 may select a synthetic form at step 605. In this process, the synthetic form selection may be performed manually or randomly. In the case of manual selection, it may be performed through the input device 120 of the electronic device 100, and in the case of random selection, data set generation may be automated.

Meanwhile, at step 601b, the electronic device 100 may obtain an original good product image of the smart phone panel. Also, at step 601c, the electronic device 100 may perform depth map extraction based on the original good product image obtained at step 601b.

Next, at step 607, the electronic device 100 may synthesize the result of performing the synthetic form selection for the defective part and the depth map (or segmentation mask) generated from the original good product image at step 601c.

Thereafter, at step 609, the electronic device 100 may synthesize the depth map synthesis result with the original good product image of the smart phone panel.

As a result, at step 611, the electronic device 100 may generate a synthetic defect image of the smart phone and store the generated synthetic defect image as a training data set for machine learning. As shown at step 611, in the case where the depth map (or segmentation mask) is applied, the synthetic defect image to which a correction effect based on the depth map is applied may be generated. By applying respective depth maps to various original good product images, the electronic device 100 may store and manage various synthesized defect images as a data set.

The above-described data set generation method of the present invention can be applied, without limitation, to not only the smart phone panel, but also a solar panel, building/facility exterior (windows, concrete, etc.), tunnels, roads, vehicle interior and exterior, electronic products, electronic components, wafers, and the like.

For example, in relation to constructing a training data set for chestnuts, which is a type of food, when a chestnut-related original defect image is collected, the electronic device 100 may extract a defective part from the chestnut-related original defect image. In relation to extracting the defective part, the electronic device 100 may apply the same image analysis, binarization, object detection, or color evaluation, as applied to the panel, to the chestnut image to extract the defective part having a form different from the surrounding area.

Meanwhile, the electronic device 100 may obtain an original good product image of chestnut, which is a type of food. Also, the electronic device 100 may perform depth map extraction based on the obtained original good product image of chestnut.

Next, the electronic device 100 may generate a synthesized image. For example, the electronic device 100 may synthesize the extracted chestnut-related defective part, the obtained chestnut-related original good product image, and the extracted chestnut-related depth map (or segmentation mask).

Additionally, the electronic device 100 may generate a chestnut-related synthesized good product image (or a restored good product image) through a difference between the synthesized image and the obtained chestnut-related defect image.

Through the above-described process, for a food item (e.g., chestnuts), the electronic device 100 may obtain a synthetic defect image, a restored good product image, and a defective part, and store the obtained data as a training data set for machine learning.

On the other hand, in the case where the depth map (or segmentation mask) is applied in the above description, a chestnut (food) related synthetic defect image to which a correction effect based on the depth map is applied may be generated. As such, by applying respective depth maps to various chestnut-related original good product images, the electronic device 100 may store and manage various chestnut-related synthesized defect images as a data set.

In various examples, in relation to constructing a training data set for a plurality of specific foods (e.g., chestnuts), the electronic device 100 may collect an original image in which the plurality of specific foods are arranged.

For example, the electronic device 100 may extract a plurality of defects from the original image containing a plurality of defective chestnuts (foods). Through this process, the electronic device 100 may obtain defective chestnut parts including a plurality of defects from the image containing chestnuts (including defects) which are a plurality of foods. That is, the electronic device 100 may extract a plurality of defects from the image in which a plurality of foods are arranged, as well as extracting only one defect from one original defect image.

The electronic device 100 may adjust at least one of a size, relative position, and rotation state of each of a plurality of defects disposed in the defective part. During the adjustment process, the electronic device 100 may adjust the plurality of defects contained in the defective part to correspond to respective positions of foods in the original good product image. For example, the electronic device 100 may detect the edges of respective foods included in the original good product image, and adjust the position, size, and rotation state of the defects so that at least some of the defects are disposed within a region defined by the corresponding edges. Based on this, the electronic device 100 may obtain a synthesized defect image in which the defective part having a plurality of defects is applied to each food.

In addition, the electronic device 100 may generate a restored good product image including a plurality of foods by removing a plurality of defective parts from the synthesized defect image.

Through the above process, the electronic device 100 may generate a synthetic defect image for a plurality of foods and store the generated synthetic defect image as a training data set for machine learning. Additionally, the electronic device 100 may calculate a depth map (or segmentation mask) corresponding to the acquired original good product image including a plurality of foods. In this case, the obtained depth map may include depth values for the respective foods.

As described above, the data set generation method of the present invention can be applied not only to smart phone panels but also to food defect detection.

FIG. 7 is a diagram illustrating a hardware system for implementing an electronic device supporting data set generation according to an embodiment of the present invention.

Referring to FIG. 7, the electronic device 100 that supports the above-described data set generation may include, for example, a mobile terminal (such as a smart phone), a notebook, a desktop computer, a laptop computer, a wired or wireless type mobile or fixed controller having a user interface, or a server. Of course, all types of devices equipped with operation means and communication means may also be included.

For reference, when the electronic device 100 is implemented in the form of a server, it may be implemented in the form of, for example, a web server, a database server, a proxy server, or the like. One or more of various kinds of software that enables a network load balancing mechanism or service device to operate over the Internet or other network may be installed, and this may make it possible to be implemented as a computerized system.

Here, the network may be an http network, a private line, an intranet, or any other network, and respective components in the system according to an embodiment of the present invention may be connected through a secure network so that data is not attacked by any hacker or other third party.

Each component in the electronic device 100 described above may be implemented in the form of a software module or hardware module executed by a processor, or a combination of a software module and a hardware module.

As such, a software module, a hardware module, or a combination thereof executed by a processor may be implemented in an actual hardware system (e.g., a computer system).

Thus, hereinafter, a hardware system 2000 in which the electronic device 100 according to an embodiment of the present invention is implemented in a hardware form will be described with reference to FIG. 7.

As shown in FIG. 7, the hardware system 2000 according to an embodiment of the present invention may include a processor 2100, a memory interface 2200, and a peripheral device interface 2300.

These respective elements in the hardware system 2000 may be individual components or be integrated into one or more integrated circuits and may be combined by a bus system (not shown).

Here, the bus system is an abstraction that represents any one or more separate physical buses, communication lines/interfaces, and/or multi-drop or point-to-point connections, connected by appropriate bridges, adapters, and/or controllers.

The processor 2100 serves to execute various software modules stored in the memory 2210 by communicating with the memory 2210 through the memory interface 2200 in order to perform various functions in the hardware system.

In the memory 2210, at least some of the communication module 110, the first encoder 151, the second encoder 152, and the decoder 153, and the temporary buffer 154, which are components of the electronic device 100 described above with reference to FIG. 2, may be stored in the form of software modules, and the operating system (OS) may be further stored.

The operating system (e.g., embedded operating system such as I-OS, Android, Darwin, RTXC, LINUX, UNIX, OS X, WINDOWS, or VxWorks) includes various procedures, command sets, software components and/or drivers that control and manage general system tasks (e.g., memory management, storage device control, power management, etc.) and plays a role in facilitating communication between various hardware modules and software modules.

The memory 2210 may include a memory hierarchy including, but not limited to, a cache, a main memory, and a secondary memory. The memory hierarchy may be implemented via, for example, any combination of RAM (e.g., SRAM, DRAM, DDRAM), ROM, FLASH, magnetic and/or optical storage devices (e.g., disk drive, magnetic tape, compact disk (CD), digital video disc (DVD)).

The peripheral device interface 2300 serves to enable communication between the processor 2100 and peripheral devices.

The peripheral devices are to provide different functions to the hardware system 2000, and in one embodiment of the present invention, a communicator 2310 may be included, for example.

The communicator 2310 serves to provide a communication function with other devices. For this purpose, the communicator 2310 may include, for example, but not limited to, an antenna system, an RF transceiver, one or more amplifiers, a tuner, one or more oscillators, and a digital signal processor, a CODEC chipset, and a memory, and may also include a known circuit that performs this function.

The communicator 2310 may support communication protocols such as, for example, WLAN (Wireless LAN), DLNA (Digital Living Network Alliance), Wibro (Wireless Broadband), Wimax (World Interoperability for Microwave Access), GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), IEEE 802.16, LTE (Long Term Evolution), LTE-A (Long Term Evolution-Advanced), 5G communication system, WMBS (Wireless Mobile Broadband Service), Bluetooth, RFID (Radio Frequency Identification), IrDA (Infrared Data Association), UWB (Ultra-Wideband), ZigBee, NFC (Near Field Communication), USC (Ultra Sound Communication), VLC (Visible Light Communication), Wi-Fi, Wi-Fi Direct, and the like. In addition, as wired communication networks, wired LAN (Local Area Network), wired WAN (Wide Area Network), PLC (Power Line Communication), USB communication, Ethernet, serial communication, optical/coaxial cables, etc. may be included. This is not a limitation, and any protocol capable of providing a communication environment with other devices may be included.

In the hardware system 2000 according to an embodiment of the present invention, each element of the electronic device 100 stored in the memory 2210 in the form of a software module performs an interface with the communicator 2310 via the memory interface 2200 and the peripheral device interface 2300 in the form of a command executed by the processor 2100, thereby supporting efficient generation and storage management of a data set.

As described above, according to the method and device according to an embodiment of the present invention, by automating or semi-automating the generation of a data set for training a machine learning model for defect detection or defect type classification, it is possible to reduce the waste of manpower required for constructing the data set, efficiently construct the data set, and reduce industrial costs including human resources required for data collection.

Meanwhile, functional operations described herein may be implemented as digital electronic circuits, or implemented as computer software, firmware, or hardware including the structure disclosed herein and structural equivalents thereof, or implemented with a combination thereof. The subject matter described herein may be implemented with one or more computer program products, that is, one or more modules of computer program instructions encoded on a tangible program storage medium for execution by or for controlling the operation of a processing system.

A computer-readable medium may be a machine-readable storage device, a machine-readable storage substrate, a memory device, a composition of matter that affects a machine-readable propagation-type signal, or a combination thereof.

In this disclosure, the term ‘system’ or ‘device’ encompasses all mechanisms, devices, and machines for processing data, including, for example, a programmable processor, a multi-processor, or a computer. The processing system may include, in addition to hardware, code that forms an execution environment for a computer program upon request, such as, for example, code constituting processor firmware, a protocol stack, a database management system, an operating system, or a combination thereof.

A computer program (also known as a program, software, software application, script or code) may be written in any form of programming language, including compiled or interpreted language, a priori or procedural language, and may be deployed in any form including stand-alone programs or modules, components, subroutines, or other units suitable for use in a computer environment. A computer program does not necessarily correspond to a file in a file system. A program may be stored in a single file provided to the requested program, or in multiple interacting files (e.g., one or more modules, subprograms, or files that store portions of code), or in a portion (e.g., one or more scripts stored within a markup language document) of a file that holds other programs or data. A computer program may be deployed to be executed on a single computer or multiple computers located at one site or distributed across multiple sites and interconnected by a communication network.

On the other hand, computer readable media suitable for storing computer program instructions and data may include all forms of non-volatile memory, media and memory devices, including semiconductor memory devices such as EPROM, EEPROM and flash memory devices, magnetic disks such as internal hard disks or external disks, magneto-optical disks, and CD-ROM and DVD-ROM disks. The processor and the memory may be supplemented by, or incorporated into, special purpose logic circuitry.

An implementation of the subject matter described herein may be implemented in a computing system that includes a back-end component such as a data server, a middleware component such as an application server, a front-end component such as a client computer having a web browser or graphical user interface through which a purchaser may interact with an implementation of the subject matter described herein, or any combination of one or more of such back-end, middleware, and front-end components. The components of the system are inter-connectable by any form or medium of digital data communication, such as, for example, a communication network.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Also, although the present specifications describe that operations are performed in a predetermined order with reference to a drawing, it should not be construed that the operations are required to be performed sequentially or in the predetermined order, which is illustrated to obtain a preferable result, or that all of the illustrated operations are required to be performed. In some cases, multi-tasking and parallel processing may be advantageous. Also, it should not be construed that the division of various system components are required in all types of implementation. It should be understood that the described program components and systems are generally integrated as a single software product or packaged into a multiple-software product.

While this disclosure has been particularly shown and described with reference to an exemplary embodiment thereof, it will be understood by those skilled in the art that various changes in form and details may be made therein without departing from the scope of this disclosure as defined by the appended claims.

According to the method and device for generating a training data set in the present invention, it is possible to generate defect data for training at a lower cost and overcome the limitations of existing technologies, so that the applicable device has sufficient possibility of commercialization or sales. In addition, since it can be clearly implemented in reality, there is industrial applicability.

What is claimed is:

1. A method for generating a data set for training, the method comprising:
collecting an original good product image and an original defect image;
extracting a defective part from the original defect image; and
mixing the extracted defective part with the original good product image,
wherein mixing includes performing mixing of latent vectors between the defective part and the original good product image in a latent space of an artificial neural network.

2. The method of claim 1, wherein performing mixing includes:
calculating a first latent vector by providing the original good product image as an input to a first encoder, and calculating a second latent vector by providing at least the defective part as an input to a second encoder; and
mixing the first latent vector and the second latent vector.

3. The method of claim 2, wherein calculating the second latent vector includes:
extracting a depth map or segmentation mask corresponding to the original good product image;
applying the defective part to the depth map or segmentation mask; and
providing a result of applying the defective part to the depth map or segmentation mask to the second encoder as an input.

4. The method of claim 3, wherein applying the defective part to the depth map includes:
applying the defective part to a depth change point in the depth map.

5. The method of claim 3, wherein applying the defective part to the depth map or segmentation mask includes:
transforming at least one of position, size, and shape of the defective part in response to a random input or an input through an input device; and
applying the transformed defective part.

6. The method of claim 1, wherein performing mixing includes:
performing adjustment of at least one coefficient value applied to mixing of the latent vectors.

7. An electronic device for supporting generation of a data set for training, the electronic device comprising:
a memory storing an original good product image and an original defect image; and
a processor functionally connected to the memory and configured to:
extract a defective part from the original defect image, and
perform an operation of mixing the extracted defective part with the original good product image,
wherein in the mixing operation, the processor is configured to perform mixing of latent vectors between the defective part and the original good product image in a latent space of an artificial neural network.

8. The electronic device of claim 7, wherein the processor is configured to:
calculate a first latent vector by providing the original good product image as an input to a first encoder, calculate a second latent vector by providing at least the defective part as an input to a second encoder, and then mix the first latent vector and the second latent vector.

9. The electronic device of claim 8, wherein in relation to calculating the second latent vector, the processor is configured to:
extract a depth map or segmentation mask corresponding to the original good product image, apply the defective part to the depth map or segmentation mask, and provide a result of applying the defective part to the depth map or segmentation mask to the second encoder as an input.

10. The electronic device of claim 9, wherein in a process of applying the defective part to the depth map, the processor is configured to:
apply the defective part to a depth change point in the depth map.

11. The electronic device of claim 9, wherein in a process of applying the defective part to the depth map or segmentation mask, the processor is configured to:
transform at least one of position, size, and shape of the defective part in response to a random input or an input through an input device, and apply the transformed defective part.

12. The electronic device of claim 9, wherein in a process of performing mixing, the processor is configured to:
perform adjustment of at least one coefficient value applied to mixing of the latent vectors.
